(19) United States
(12) Patent Application Publication
(10) Pub. No.: US 2009/0277536 A1
(43) Pub. Date: Nov. 12, 2009

(54) TREE CLIMBING AND TRIMMING DEVICE

(76) Inventor: John Scott, Belton, SC (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/296,775

(22) PCT Filed: Apr. 11, 2007
(86) PCT No.: PCT/US07/66387

§ 371 Date: Oct. 10, 2008

Related U.S. Application Data
(60) Provisional application No. 60/791,028, filed on Apr. 11, 2006.

(51) Int. Cl. A01G 23/095

(52) U.S. Cl. 144/24.13

(57) ABSTRACT

A tree trimming apparatus may include a first frame portion and a second frame portion that are spaced apart from each other. Each frame portion may have a generally circular shape so that the entire frame of the apparatus may be positioned around the trunk of a tree. A vertical actuator connects the first and second frame portions and may operate to increase or decrease the distance between those portions. Further, a horizontal actuator may be positioned on each of the portions with each horizontal actuator operating to extend into the interior of each frame portion and engage a tree trunk. Additionally, a cutting device may be positioned on the first frame portion to assist in the cutting or trimming of the tree.

### CROSS-REFERENCE TO RELATED APPLICATIONS

This application claims priority of U.S. Provisional Patent Application Ser. No. 60/791,028 filed Apr. 11, 2006, which is incorporated herein by reference.

### BACKGROUND OF THE INVENTION

1. Field of the Invention

Disclosed herein is an apparatus for climbing and trimming a tree or plant. More specifically, disclosed herein is an apparatus having a frame that may be raised or lower along a tree trunk using a stepped motion created by manipulating an arrangement of hydraulically or pneumatically driven arms. The apparatus may include a cutting device that may be used to remove damaged, dead or otherwise unwanted limbs, foliage, bark or the like from the tree or plant.

2. Reference to Related Art

U.S. Pat. No. 3,356,113 to Del Perugia disclosed a method, apparatus and machine for climbing and sectioning a standing tree. The Del Perugia apparatus included a frame that could be positioned around a tree trunk and a number of spiked wheels that extended into an interior of the frame to engage the trunk. The apparatus could be propelled up or down the tree trunk by rotating the wheels in a direction selected by the user. Del Perugia also disclosed that a cutting tool could be positioned on the frame to cut or otherwise section a tree.

U.S. Pat. No. 6,672,346 to Heckmaier disclosed a tree-trimming machine. Like Del Perugia, Heckmaier also disclosed a frame that could be positioned around a tree trunk and the use of a number of wheels to engage, and then propel, the frame up or down the trunk.

Del Perugia, Heckmaier and other prior art devices relied upon wheels, or other rolling contacts, to raise and lower their respective apparatus along a tree trunk. However, if the trunk face is irregularly shaped one or more of the wheels may not engage and/or be able to traverse certain sections of the trunk. A rolling contact may also be susceptible to a loss of traction or grip when the trunk is wet or slippery. Therefore, it would be advantageous to have a tree climbing and trimming apparatus capable of overcoming these and other obstacles.

### SUMMARY OF THE INVENTION

Disclosed herein is a tree trimming apparatus that may include a frame having an upper frame portion and a lower frame portion. The frame portions may be spaced from each other and have a circular shape such that the entire frame could be positioned around the trunk of a tree. For example, each frame portion may include a pair of hinged body sections that enable each frame portion to be easily opened and closed.

One or more fluid powered vertical actuators may connect the upper and lower frame portions and function to increase or decrease the distance between the frame portions.

Additionally, one or more fluid powered horizontal actuators may be positioned on each of the upper and lower frame portions. Each horizontal actuator may function to extend into the interior of its respective frame portion and engage a tree trunk positioned in that interior space.

A track positioned on the upper frame portion and a cutting device having a chain saw or similar cutting tool may be movably positioned on the track

### BRIEF DESCRIPTION OF THE DRAWINGS

Reference will now be had to the attached drawings wherein like reference numerals refer to like parts throughout and wherein:

FIG. 1 is an environmental perspective view of an embodiment of a tree climbing and trimming apparatus;

FIG. 2 is a top, planar view of the embodiment of a tree climbing and trimming apparatus;

FIG. 3 is a side, planar view of the embodiment of a tree climbing and trimming apparatus;

FIG. 4 is a top, planar view of the embodiment of a tree climbing and trimming apparatus wherein the apparatus is shown in the unlocked or open position;

FIG. 5 is a top, planar view of an embodiment of a trolley positioned on a track of the embodiment of a tree climbing and trimming apparatus;

FIGS. 6A-6D are partial, side, planar views of the embodiment of a tree climbing and trimming apparatus showing the movement of the actuators of the apparatus during a tree climbing operation;

FIG. 7 is an environmental perspective view of an embodiment of a tree climbing and trimming apparatus having a power supply unit for a cutting device movably mounted on a track; and

FIG. 8 is a planar, side view of a tilting/pivoting assembly for the cutting device of the apparatus.

### DETAILED DESCRIPTION OF THE INVENTION

A tree trimming apparatus may include a climbing device and a ground based support device, module or assembly that may communicate with a climbing device using an umbilical and/or a remote control system. The climbing device may include a frame that may be positioned around a tree trunk. The frame may have a first (upper) frame portion and a second (lower) frame portion. These frame portions may be spaced apart and secured together by one or more vertical actuators. One or more horizontal actuators may be pivotably secured to each of the frame portions and may operate to engage and disengaged from the tree trunk. A cutting device may be removably positioned on a track (or elsewhere on the climbing device) that extends around first frame portion. As mentioned above, the ground support device may be connected to the climbing device by an umbilical (or via remote control) to provide the climbing device with power, fluid and control inputs.

To climb a tree, the frame of the climbing device may first be positioned around a tree trunk. The horizontal actuator(s) on the lower frame portion may then be extended to engage the trunk. Thereafter, the vertical actuator(s) may be operated to lift the first frame portion upwardly along the tree trunk. After the first frame portion has been lifted by the vertical actuator(s), the horizontal actuator(s) of the first frame portion may be extended to engage trunk; with the horizontal actuator(s) of the second frame portion retracting soon thereafter to disengage from the tree trunk. Finally, the vertical actuator(s) may operate to lift the second frame portion upward toward the first frame portion. After the climbing apparatus reaches an appropriate height as determined by the user, the cutting device may be operated to trim the tree. To descend a tree, the movement of the actuator(s) may be reversed.

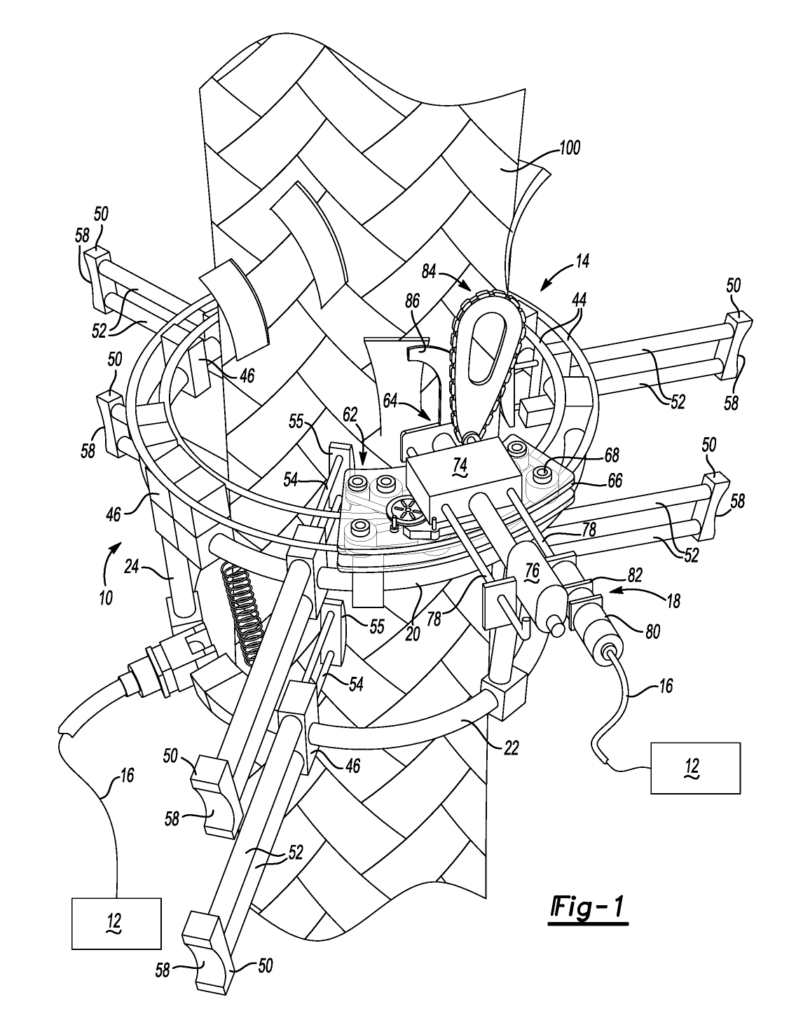

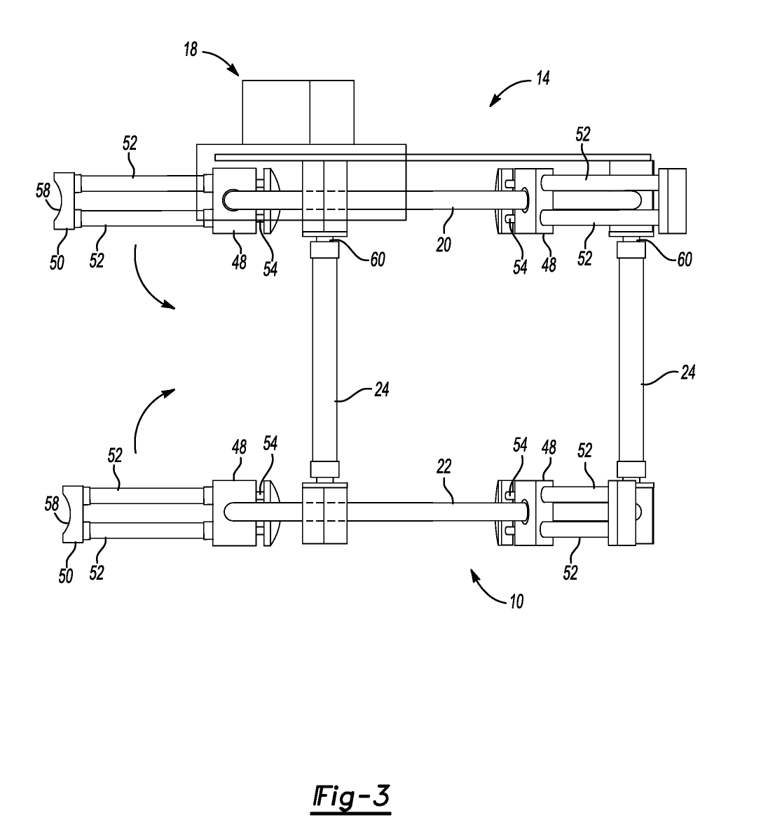

Referring now to FIGS. 1-4 and 6A-6D, there is shown a tree trimming apparatus 10 that may include a support device 12 and a climbing device 14 that may be connected to the support device 12 by one or more umbilicals 16 or by, for certain control elements, a wireless communication system (not shown). A cutting device 18 may be removably mounted to the climbing device 14. The climbing device 14 may include a frame having first frame portion 20 and a second frame portion 22 that is spaced apart from the first frame portion 20. One or more vertical actuators 24 may connect the first frame portion 20 to the second frame portion 22. Further, one or more horizontal actuators 26 (first frame portion), 28 (second frame portion) may be pivotably mounted to each of the first and second frame portions 20, 22 to engage or disengage a tree trunk 100.

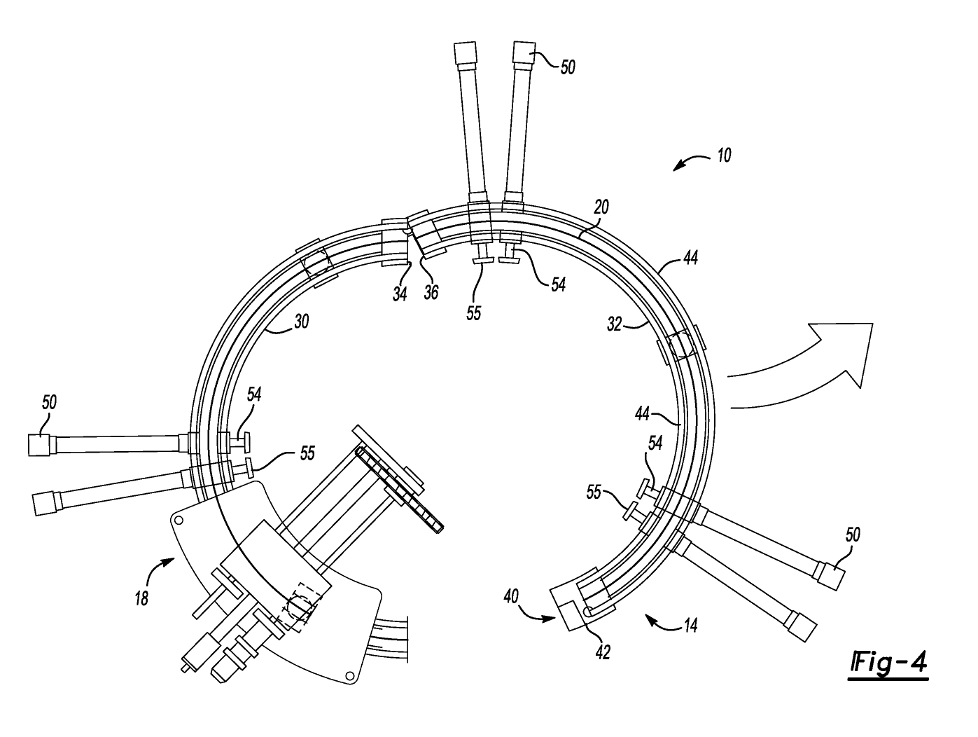

Still referring to FIGS. 1-4 and 6A-6D, the first and second frames 20, 22 may be constructed so that are easily positioned around a tree trunk 100. For example, the frame portions 20, 22 may constructed with an outside diameter of 36 inches, an inside diameter of 26 inches and a height of 26 inches using round or square aluminum tubing or a material having similar strength and weight characteristics. As shown in FIG. 4, the first and second frame portions 20, 22 may each be constructed as a pair of C-shaped or half-circle body sections 30, 32. As such, the frames 20, 22 may have a generally circular shape. However, it will be appreciated that the frame portions 20, 22 may also be constructed in the shape of a hexagon, octagon or another type of polygon or multi-sided object. The sections 30, 32 of each frame portion 20, 22 may be pivotably secured at one end 34, 36 by an Ultra-High Molecular Weight (“UHMW”) polyethylene hinge 38 and also include, at an opposite end 40, a heavy duty “latch action clamp” 42 or similar closure device to allow the sections 30, 32 to be releasably locked together.

Referring now to FIGS. 1, 2 and 4, a track 44 may be positioned along a top of the first frame portion 20. For example, the track 44 may be constructed as a smooth, level track formed from two separate aluminum bars spaced three inches apart. The track 44 may extend 360 degrees around the entire circumference/length of the first frame 20 or, alternatively only partially around the first frame portion 20. As will be described below, in operation the track 44 may be electrified using a 24V DC power supply and may be insulated from the frame using UHMW polyethylene stands 46.

Referring now to FIGS. 1-4, the horizontal actuator(s) 26, 28 on the first and second frame portions 20, 22 may include a front 48 and a rear 50 body portion, a pair of 1¼ inch pneumatic cylinders 52 having extendable shafts 54, and a claw or gripper 55 that connects the ends of the extendable shafts 54. The extendable shafts 54 may have stroke of about 12 inches and the horizontal actuator(s) themselves may be dimensioned to have a length (measuring from the ends of each body portions) of about 19¾ inches, a height of about 6 inches and a width of about 1¾ inches. The gripper 55 may be constructed as a rubber coated UHMW polyethylene body. The rubber coating on each gripper 55 may allow the gripper 55 to grab a tree trunk 100 without slipping. Further, the use of a rubber coated gripper 55 prevents the gripper 55 from becoming invasive to the tree bark. Air tubing and fittings (¼ inch)(not shown) may also be provided on each horizontal actuator 26, 28.

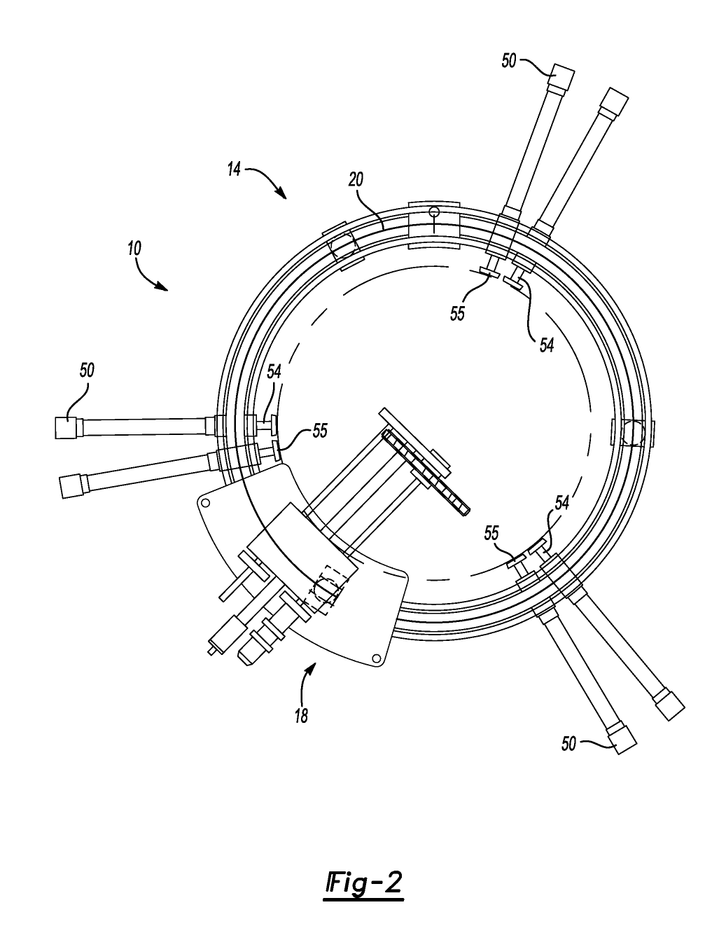

Still referring to FIGS. 1-4, and as mentioned above, a horizontal actuator(s) 26, 28 may be pivotably mounted on the first and second frame portions 20, 22 such that the extendable shaft(s) 54 of each actuator 26, 28 may extended radially inward into an interior area 56 defined by the frame portions 20, 22 (i.e., an area that may be occupied during normal operation by the tree trunk 100). As best shown in FIG. 2, in the disclosed embodiment, three horizontal actuators 26, 28 may be positioned at intervals of 120 degrees on each of the frame portions 20, 22; although greater or fewer numbers of actuators may also be used. However, it has been found that three horizontal actuators may produce a combine “clamping” force of approximately 1000 pounds.

Still referring to FIGS. 1-4, each of the horizontal actuators 26, 28 may also be pivoted from a horizontal orientation for use, to a vertical orientation for transportation and storage. For example, in the disclosed embodiment, each horizontal actuator 26, 28 may be secured to the first or second frame portion 20, 22 by two, 2 inch external retaining rings (not shown) positioned on the front body portion 48 of the horizontal actuator 26, 28. The rings allow a user to secure each horizontal actuator 26, 28 in a horizontal orientation or, alternatively, pivot and lock a horizontal actuator 26, 28 upwardly toward the opposing frame portion. Further, a small crescent cut 58 in the rear body portion 50 of each horizontal actuator 26, 28 permits the horizontal actuator to be removably secured (i.e., frictionally engage) to the opposing frame portion 20 or 22.

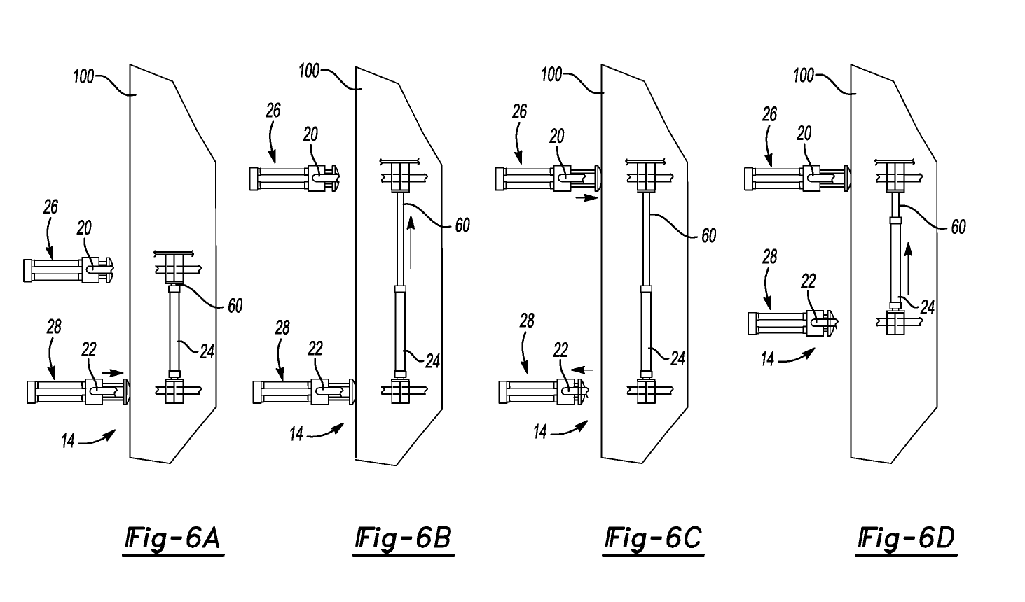

Referring now to FIGS. 1, 3 and 6A-6D, similar to the horizontal actuators 26, 28 described above, the vertical actuator(s) 24 may include a twelve-inch pneumatic cylinder having a two-inch bore, reciprocating shaft 60. As shown in FIG. 1, the vertical actuator(s) 24 of the climbing device 14 may have one end 62 secured to one of the first or second frames 20, 22 and the other end or the shaft 60 secured to the other of the first or second frames 20, 22. As will be described in greater detail below (and as shown in FIGS. 6A-6D), operation of the vertical actuator(s) 24 may cause the distance between the frame portions 20, 24 to increase or decrease according to the needs of the user and as necessary to enable the climbing device 14 to ascend or descend a tree trunk 100.

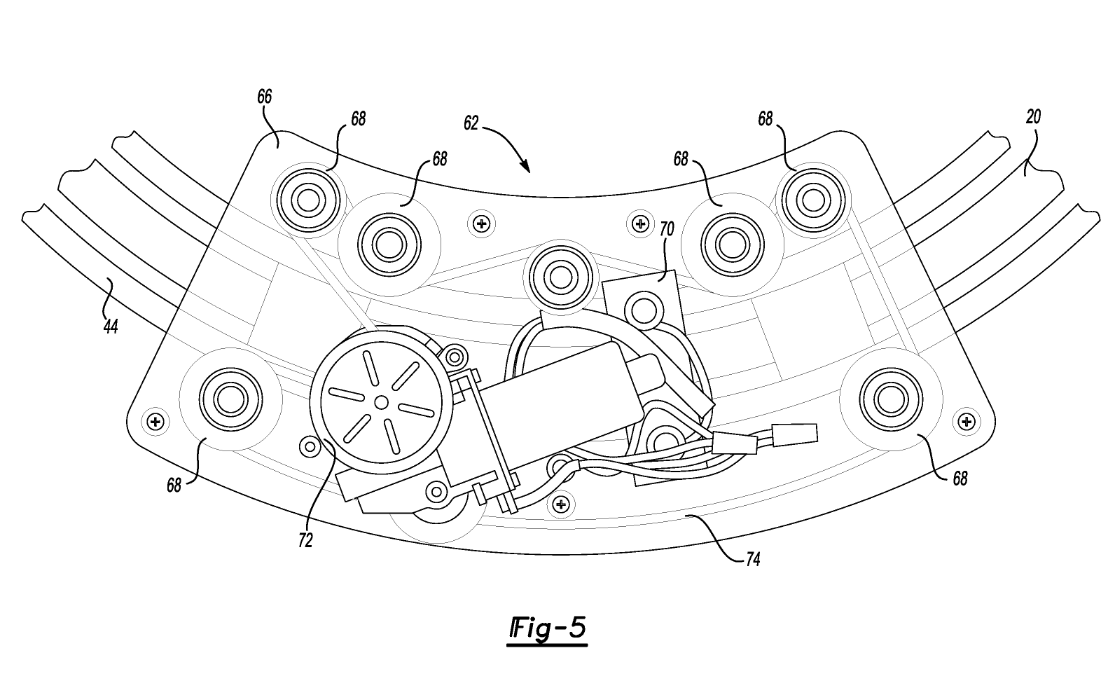

Referring now to FIGS. 1, 2, 4 and 5, the cutting device 18 may be removably positioned on the track 44 of the first frame 20 and may include a trolley 62 (or tram or carriage) and a cutting tool 64. The trolley 62 may have a plastic body 66 and a plurality of wheels 68, one or more of which may be spring biased into engagement with the track 44. For example, the trolley 62 may include six actal drive wheels or rollers 68 located in six (6) different locations under the trolley, four of which may be used to provide the locomotion for the trolley. The rollers may be constructed DELRIN® or actal plastic. The drive rollers 68 may also be are fitted with a sleeve of surgical tubing to allow the rollers to grip the track while, at the same time, allowing a certain amount of slippage” to protect the trolley from jamming. Two (2) spring loaded carbon brushes (see brush support 70) or similar contacts that contact the track 44 and transmit power and/or control inputs though the track 44 to the trolley 62. Further, a reversible DC gear motor 72 may also be mounted inside the trolley 62 to provide movement to the rollers 68. Stepping gears (not shown) and a double stepped belt 73 may also be used connect the entire movement together.

The trolley 62 may be constructed to have a low profile since it has to support the weight of the cutting tool 64. The trolley 62 should also “ride” flush with the track 44 so only the body 66 of the trolley 62 and the track 44 support the cutting tool 64 since, in operation, such an arrangement may function to keep debris from collecting between the track 44 and the trolley 62.

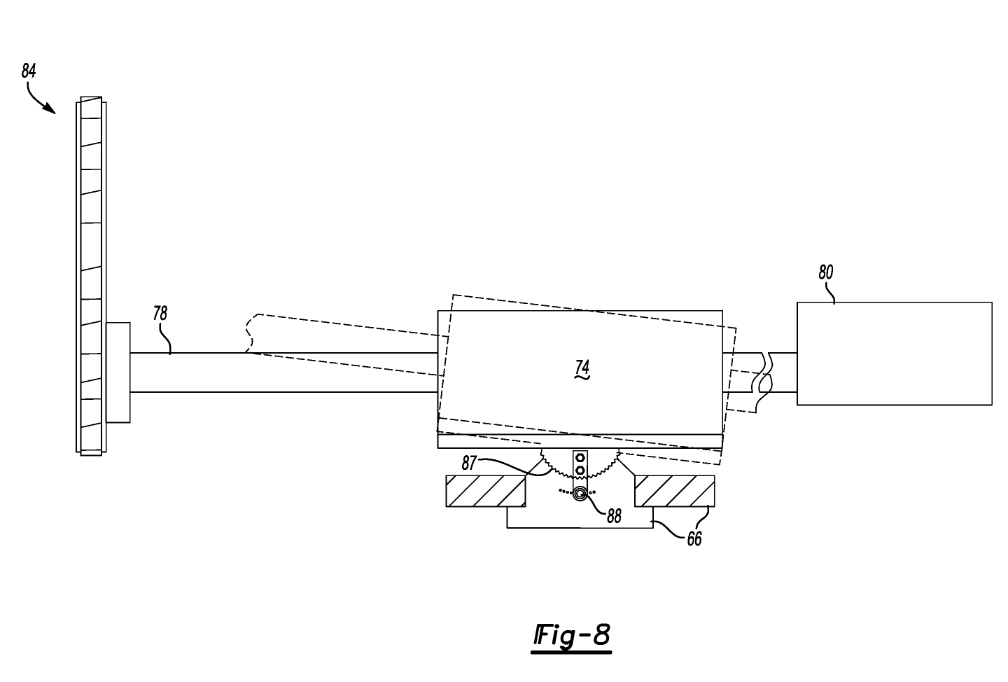

Referring now to FIGS. 1, 2, 4, 5 and 8, the cutting tool 64 may be constructed so that it may be radially extended into the interior 50 of the frame and thereby engage the tree 100. For example, the cutting tool 64 may include an electric driven linear slide having a slide body 74, a DC powered 10 inch stroke linear actuator 76, two ½ inch hardened steel support rods 78, one of which may be used as a drive shaft for the cutting tool motor 80, a bridge support and mount 86 for the motor 82, a small bow bar and chain (i.e. a chainsaw) 84 and a bar mount with a built-in “scraper”. The cutting tool 64 may be removably mounted on the trolley 62. For example, the cutting tool 64 may be detached from the trolley 62 for transport and/or storage. Then, when the climbing device 14 is installed around a tree trunk 100, the user may install the cutting tool 64 on the trolley 62 and connect any control wiring. Further, as best shown in FIG. 8, the cutting tool may also be constructed so that it may be selectively tilted or angled by the user. For example, the body 74 of the cutting tool 64 may have a convex “toothed” bottom that may engage a “toothed” concave base 87 defined in the body 66 of the trolley 62. Accordingly, the user may tilt or angle the cutting tool 64 up and down so the cutting bar 84 (chain saw) cuts at an angle while the teeth of the cutting tool body 74 and the trolley 62 cooperate to lock the cutting tool 64 in position. A latch 88, or the like may be used to further secure the cutting tool 64 in position on the trolley 62 or assist in the pivoting of the cutting tooling 64.

Referring now to FIGS. 1, 2, 4 and 5, the trolley 62, and cutting tool 64 may be controlled using a wireless remote control system. Alternatively, the trolley 62, and cutting tool 64 may be controlled though inputs communicated by wires that extend from the support device 14, along the umbilical 16 to the track 44. In operation, the trolley 62 may function to allow a user to properly position the cutting tool relative to the tree trunk 100 and any unwanted foliage. For example, the trolley 62 may be used to position the cutting tool 64 directly to the right side of an unwanted palm frond (i.e. a frond the operator determines should be pruned or removed).

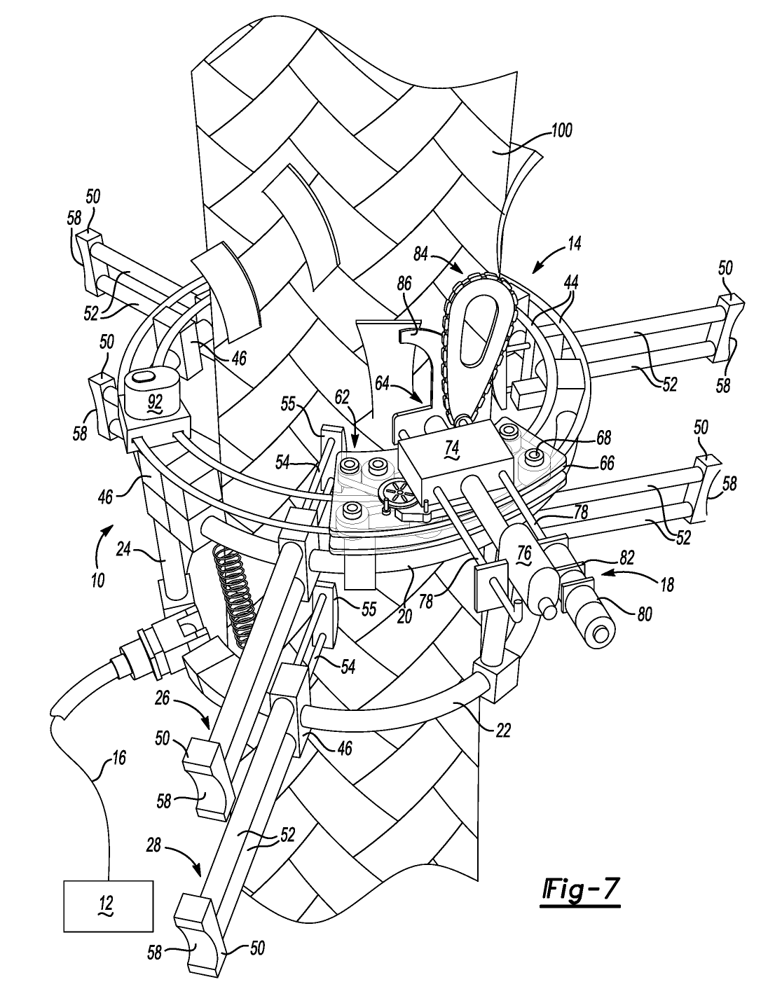

Referring now to FIGS. 1 and 7, the support device 12 may be a wheeled ground support cart (not shown) that allows a user to easily transport the necessary controls, power source, fluid (air) supply and the valve actuator(s) for the climbing device 14 into the field. As a alternative to a cart, the support device 12 may also include a vehicle such as a golf cart, a truck or van. By way of example, the support device 12 may be used to carry a fluid (air) supply for the climbing device may include a 100% duty/6 or 8 cfm air compressor and a 6 gallon reserve air tank. Likewise, support device 12 may also carry a power supply for the climbing device 14 (or more particularly the trolley 62 and cutting tool 64 of the climbing device 14) in the form of two 24V DC batteries.

Still referring to FIGS. 1 and 7, the fluid supply lines, actuator(s), electrical power supply, etc, may all be in electrical communication climbing device 14 though the use an umbilical 16 that extends from the ground support 12 to the climbing device 14. It will, of course, be appreciated that while the support device 12 has been described as a ground based device, some or all of the elements contained in or positioned thereon may be positioned on the climbing device 14 such that the climbing device may function as a completely self-contained unit controlled, for example, by remote control or an on-board computer program or both. For example, as best shown in FIG. 7, the climbing device 14 may include a second trolley 90 removably mounted to the track 44 and having a power supply 92 in the form of a two sets of 24V rechargeable lithium-ion battery packs mounted on the second trolley 90. The second trolley itself may be unpowered and free to move about the track 44. However, second trolley 92 may also transmit electrical current from its power supply 92 through the track 44 and to the trolley 62 of the cutting device 16 using power induction methods known in the art (i.e., inducing an electrical current from the second trolley 92 and through the track to the brushes of the first trolley 62).

Still referring to FIGS. 1 and 7, as mentioned above, the control of the climbing apparatus 14 may be by radio remote control or, alternatively, a “hard wired” tether remote control. For example, a joystick based a radio remote control (not shown) would allow the operator freedom to observe and control from any position around the tree.

Referring now to FIG. 6A-6D, as mentioned above, in operation the climbing device 14 may operate through selective movement of the actuator(s) 24, 26, and 28 to ascend or descend a tree trunk 100. For example, once the climbing device 14 is positioned around a tree trunk 100, the horizontal actuator(s) 28 on the second frame portion 22 may extend and lock (or grip) onto the tree trunk 100. Then, with horizontal actuator(s) 26 on the first frame portion 20 placed in a retracted positioned (i.e., free from the tree trunk) the vertical actuator(s) 28 may extend, causing the first frame portion 20 (including the cutting device 18) to move upwards approximately 12 inches. After being lifted, the horizontal actuator(s) 26 on the first frame portion 20 may now extended to lock to the trunk 100. Next, by releasing the horizontal actuator(s) on the second frame portion 22 and retracting vertical actuator(s) 28, the second frame portion 22 may be pulled up toward the first frame portion 20 approximately 12 inches. Therefore, in one sequence of operation, the complete assembly may move approximately 12 inches upward on the tree trunk 100. This climbing action may be repeated until the first frame portion (with the trimming or cutting module attached) is at a height where trimming or cutting of the fronds can commence. It will also be appreciated that the stepping action of the climbing device 14 (up or down a tree trunk 100) may be automated using suitable computer aid controls positioned on, or associated with, the support device 12.

Having thus described my invention, various other embodiments will become known to those of skill in the art that do not depart from the scope of the present invention.

I claim:

1. A tree trimming apparatus comprising:
a first frame portion and a second frame portion, the frame portions being spaced from each other with each frame portion forming a closed loop defining an interior;
a vertical actuator connecting the first and second frame portions and being operable to increase or decrease the distance between the frame portions;
a horizontal actuator positioned on each of first and second frame portions, each horizontal actuator being operable to extend into the interior of each frame portion; and
a cutting device positioned on the first frame.

2. The tree trimming apparatus of claim 1, wherein the first and second frame portions each include a pair of body sections, each body section being secured at one end by a hinge and having a closure device at an end opposite the hinge.

3. The tree trimming apparatus of claim 1, wherein the first frame portion includes a track.

4. The tree trimming apparatus of claim 3, wherein the cutting device comprises a trolley and a cutting tool, the trolley being movably mounted on the track and the chain saw being mounted to the trolley.

5. The tree trimming apparatus of claim 1, further comprising a second trolley movably mounted on the track, the second trolley including a power supply for the cutting device.

6. The tree trimming apparatus of claim 5, wherein the power supply for the cutting device comprises a battery pack.

7. The tree trimming apparatus of claim 1, further comprising a support device having an umbilical, the umbilical extending from the support device to at least one of the frame portions.

8. The tree trimming apparatus of claim 7, wherein the support device further comprises a power source for the cutting device, a fluid supply for the vertical and horizontal actuators, and a plurality of valve actuators for control of the vertical and horizontal actuators.

9. The tree trimming apparatus of claim 1, further comprising a power supply for the cutting device mounted on the first frame.

10. A tree trimming apparatus comprising:
a frame having an upper frame portion and a lower frame portion, the frame portions being spaced from each other and forming a loop having an interior, each frame portion further including a pair of body sections, each body section being pivotably secured to the other body section such that the loop may be opened and closed;
a vertical actuator connecting the upper and lower frame portions and being operable to increase or decrease the distance between the frame portions;
at least two horizontal actuators positioned on each of the upper and lower frame portions, each horizontal actuator being operable to extend into the interior of its frame portion; and
a cutting device positioned on the frame.

11. The tree trimming apparatus of claim 10, wherein the upper frame portion includes a track.

12. The tree trimming apparatus of claim 11, wherein the cutting device comprises a trolley and a cutting tool, the trolley being movably mounted on the track and the chain saw being mounted to the trolley.

13. The tree trimming apparatus of claim 11, further comprising a second trolley movably mounted on the track, the second trolley including a power supply for the cutting device.

14. The tree trimming apparatus of claim 13, wherein each horizontal actuator is spaced from another horizontal actuator on the same frame portion by 120 degrees.

15. The tree trimming apparatus of claim 11, further comprising a support device having an umbilical, the umbilical extending from the support device to at least one of the frame portions.

16. The tree trimming apparatus of claim 15, wherein the support device further comprises a power source for the cutting device, a fluid supply for the vertical and horizontal actuators, and a plurality of valve actuators for control of the vertical and horizontal actuators.

17. The tree trimming apparatus of claim 1, further comprising a power supply for the cutting device mounted on the frame.

18. A tree trimming apparatus comprising:
a frame having an upper frame portion and a lower frame portion, the frame portions being spaced from each other and forming a loop having an interior, each frame portion further including a pair of body sections, each body section being pivotably secured to the other body section such that the loop may be opened and closed;
at least two vertical actuators, each vertical actuator connecting the upper and lower frame portions and being operable to increase or decrease the distance between the frame portions;
at least two horizontal actuators positioned on each of the upper and lower frame portions, each horizontal actuator being operable to extend into the interior of its frame portion;
a track positioned on the upper frame portion; and
a cutting device movably positioned on the track.

19. The tree trimming apparatus of claim 18, further comprising a power supply for the cutting device mounted on the frame.

20. The tree trimming apparatus of claim 1, further comprising a support and control device having an umbilical, the umbilical extending from the support and control device to the frame.
